(19) United States
(12) Patent Application Publication
(10) Pub. No.: US 2022/0082853 A1
(43) Pub. Date: Mar. 17, 2022

(54) DISPLAY DEVICE

(71) Applicant: Panasonic Intellectual Property Management Co., Ltd., Osaka (JP)

(72) Inventors: Satoru TANAHASHI, Osaka (JP); Shigeo Kasahara, Hyogo (JP); Naoki Kamada, Osaka (JP); Toshiya Mori, Osaka (JP); Ken'ichi Kasazumi, Osaka (JP)

(21) Appl. No.: 17/537,138

(22) Filed: Nov. 29, 2021

Related U.S. Application Data
(63) Continuation of application No. PCT/JP2020/019157, filed on May 13, 2020.

(30) Foreign Application Priority Data
May 31, 2019 (JP) 2019-103273

(51) Int. Cl. G02B 30/27

(52) U.S. Cl. CPC G02B 30/27

(57) ABSTRACT

This display device includes: a display unit including a plurality of pixels that is arrayed; an optical element array arranged in parallel with a light exit surface of the display unit and including a plurality of optical elements that is arrayed; and a controller that controls a pixel among the plurality of pixels to be non-lighting, the pixel overlapping a boundary portion between adjacent optical elements among the plurality of optical elements in a facing direction in which the display unit and the optical element array face each other.

### BACKGROUND

### 1. Technical Field

The present disclosure relates to a display device.

### 2. Description of the Related Art

Patent Literature (PTL) 1 discloses a head-mounted light-field display system having two light-field projectors, each including a solid-state light emission diode (LED) emitter array operatively coupled to a microlens array. The two light-field projectors correspond to respective human eyes. The solid-state LED emitter array and the microlens array are positioned such that light emitted from an LED of the solid-state LED emitter array reaches the eye through at most one microlens from the microlens array. The solid-state LED emitter array physically moves with respect to the microlens array to mechanically multiplex the solid-state LED emitters to achieve resolution via mechanically multiplexing.

PTL 1 is Japanese Translation of PCT International Application No. 2015-521298.

### SUMMARY

The present disclosure is accomplished in view of the abovementioned conventional circumstances, and an object thereof is to provide a display device that improves display reproducibility by reducing optical crosstalk to adjacent optical elements in an optical element array in which a plurality of optical elements is arrayed and by suppressing blurring or generation of a double image of a stereoscopic image to be reproduced.

The present disclosure provides a display device including: a display unit including a plurality of pixels that is arrayed; an optical element array arranged in parallel with a light exit surface of the display unit and including a plurality of optical elements that is arrayed; and a controller that controls a pixel among the plurality of pixels to be non-lighting, the pixel overlapping a boundary portion between adjacent optical elements among the plurality of optical elements in a facing direction in which the display unit and the optical element array face each other.

According to the present disclosure, it is possible to improve display reproducibility by reducing optical crosstalk to adjacent optical elements in an optical element array in which a plurality of optical elements is arrayed and by suppressing blurring or generation of a double image of a stereoscopic image to be reproduced.

### BRIEF DESCRIPTION OF DRAWINGS

FIG. 1 is a plan view schematically illustrating a main part of a display device according to an exemplary embodiment.

FIG. 2 is an explanatory view of a function of a microlens and a light emitter in the display device illustrated in FIG. 1.

FIG. 3 is a block diagram illustrating an example of an internal configuration of the display device according to the exemplary embodiment.

FIG. 4 is a schematic diagram illustrating an example of a positional relationship between a display unit and a microlens array in which non-lighting pixels are provided at positions corresponding to boundary portions between microlenses.

FIG. 5 is a plan view of a first modification in which microlenses in a square array are provided in parallel.

FIG. 6 is a plan view of a second modification in which a cylindrical lens is used as a microlens.

FIG. 7 is a plan view of a third modification in which a lenticular lens is provided in a non-parallel manner.

FIG. 8 is a plan view of a fourth modification in which microlenses each having a hexagonal shape are arranged in a hexagonal array.

FIG. 9 is a plan view of a fifth modification in which microlenses each having a circular shape are arranged in a hexagonal array.

FIG. 10 is a plan view of a sixth modification in which an optical element is a pinhole.

FIG. 11 is a schematic diagram of a positional relationship between a display unit and a pinhole array in which non-lighting pixels are provided at positions corresponding to boundary portions between pinhole plates.

FIG. 12 is a plan view of a seventh modification in which pinhole plates each having a hexagonal shape are arranged in a hexagonal array.

FIG. 13 is a diagram schematically illustrating an example of an operation procedure of creating a stereoscopic image by the display device according to the exemplary embodiment.

FIG. 14 is an explanatory diagram illustrating various conditions when the configuration according to the exemplary embodiment is simulated.

FIG. 15 is an explanatory diagram illustrating a result of simulation in a case where the optical element is a microlens.

### DETAILED DESCRIPTION

### (Circumstances Leading to Contents of Exemplary Embodiment)

In the light field projector based on the microlens array in PTL 1, the microlens array includes multiple microlenses which are arrayed. In the solid-state LED emitter array, when an original image is displayed, unnecessary light is generated because light of each pixel is not unidirectional. For example, when each pixel emits light by an LED corresponding to the entire region of the light receiving surface of each microlens, light emitted from the outermost LED goes beyond the boundary portion with the adjacent microlens and enters the adjacent microlens. In this case, since the LED that is the light emission source is reconstructed such that the light beam exits from each position in the depth direction of the stereoscopic image, the light beam leaks to the adjacent microlens as interference light of light beams that reconstruct the stereoscopic image. That is, an optical crosstalk occurs. This optical crosstalk causes blurring or a double image when a stereoscopic image of a reproduction target (for example, an object or a person to be displayed) is displayed, leading to deterioration in display reproducibility.

In view of this, the following exemplary embodiment will describe an example of a display device that improves display reproducibility by reducing optical crosstalk to adjacent optical elements in an optical element array in which a plurality of optical elements is arrayed and by suppressing blurring or generation of a double image of a stereoscopic image of a reproduction target.

The exemplary embodiment that specifically describes a display device according to the present disclosure will be described below in detail with reference to the drawings as appropriate. However, unnecessarily detailed description may be omitted. For example, detailed descriptions of already known matters and duplicated descriptions of substantially identical configurations may be omitted. This is to avoid the following description from being unnecessarily redundant and to help those skilled in the art to easily understand the following description. Note that the attached drawings and the following description are provided for those skilled in the art to fully understand the present disclosure, and are not intended to limit the subject matter set forth in the appended claims.

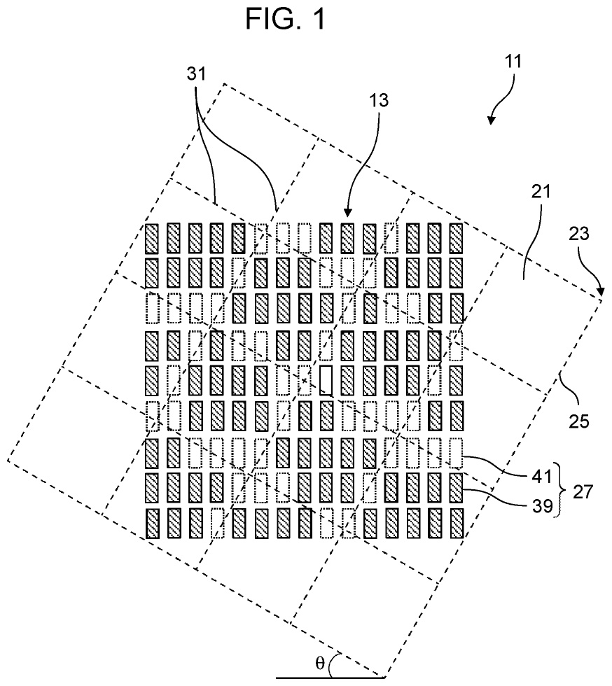

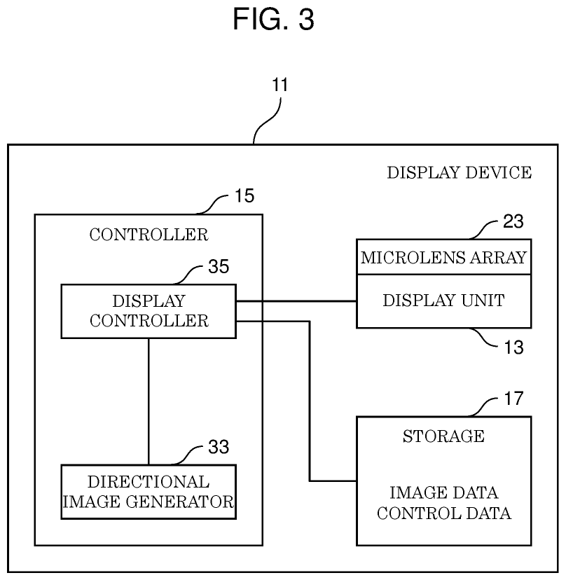

FIG. 1 is a plan view schematically illustrating a main part of display device 11 according to the exemplary embodiment. Display device 11 according to the exemplary embodiment includes display unit 13, microlens array 23 as an optical element array, controller 15, and storage 17 as main components (see FIG. 3). Details of individual configurations of display device 11 will be described later.

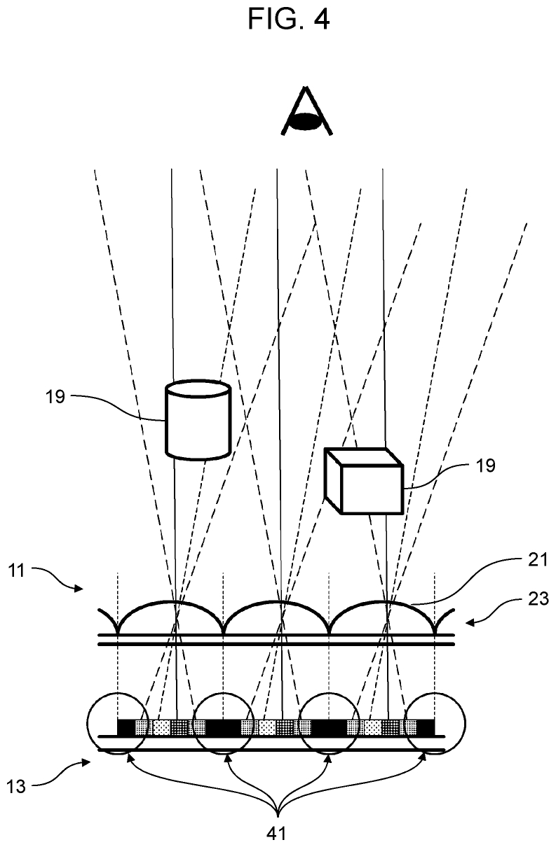

Display unit 13 includes, for example, a color liquid crystal display (LCD). Display unit 13 displays a three-dimensional image including stereoscopic image 19 (see FIG. 4) of a reproduction target (for example, an object or a person) that is to be reproduced by display device 11. Display unit 13 is provided with an optical element array. When including the abovementioned LCD, display unit 13 is provided with, for example, a backlight illuminator.

Note that display unit 13 is not limited to include the LCD described above, and may include, for example, a cathode ray tube, a light emission diode (LED) display, a plasma display, an organic electroluminescence (EL), an inorganic EL, a hologram printed matter, etc.

The optical element array is arranged in parallel with a light exit surface of display unit 13. A plurality of optical elements is arrayed in the optical element array. The optical element array is, for example, microlens array 23 in which microlenses 21 as a plurality of optical elements are arrayed. Each microlens 21 is formed in, for example, a square shape. Microlenses 21 each having square outline 25 are linearly arranged vertically and horizontally in a square array. The effective area of microlens array 23 is substantially the same as the area of display unit 13.

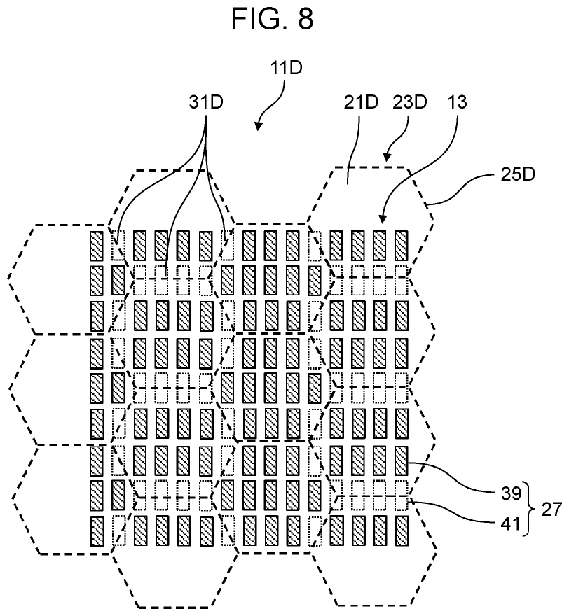

In display device 11, as illustrated in FIG. 1, the arrangement direction in which a plurality of pixels 27 constituting the LCD is arrayed is not parallel to the arrangement direction in which the plurality of microlenses 21 constituting microlens array 23 is arrayed. In display device 11, the arrangement direction of pixels 27 and the arrangement direction of microlenses 21 are not parallel to each other, so that, even if two periodic intensity distributions are overlapped, the line of intersection of the periods is less likely to be emphasized. This non-parallel state can be obtained, for example, by rotating microlens array 23 at a predetermined angle around a rotation center perpendicular to the surface of display unit 13 with respect to display unit 13. When both are arranged in a square array, rotation angle θ (see FIG. 1) is preferably in a range of, for example, about 20° to 25° which is approximately a half of 45°. Such non-parallel arrangement suppresses so-called moire and the like in display device 11. Note that, as the arrangement direction of pixels 27, pixels 27 are not limited to being arranged in a matrix as illustrated in FIGS. 1, 5, 6, 7, and 10, and may be arranged in a hexagonal array as illustrated in FIGS. 8, 9, and 12, for example.

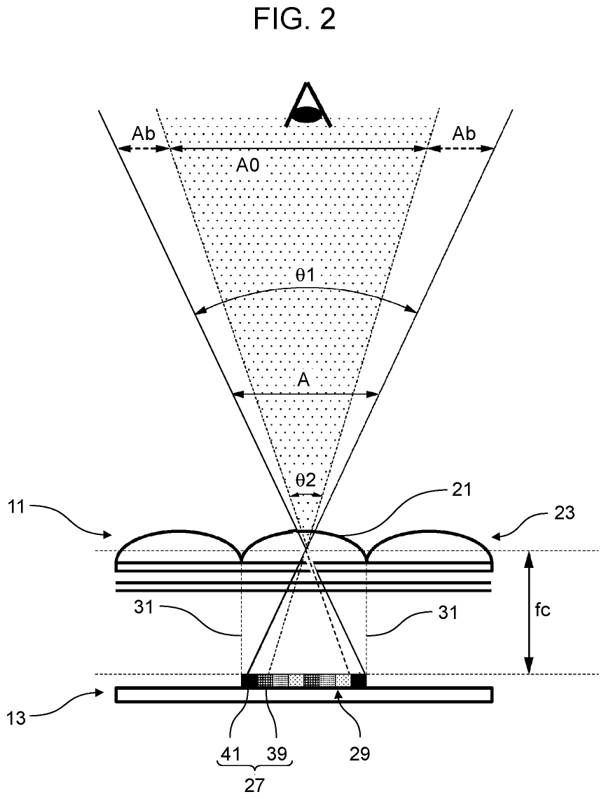

FIG. 2 is an explanatory view of a function of microlens 21 and light emitter 29 in display device 11 illustrated in FIG. 1. In display device 11, light emitter 29 is provided in display unit 13 so as to emit a light beam at angle θ2 (<emission angle θ1) smaller than emission angle θ1 of the light beam determined by focal length fc of microlens 21. Light emitter 29 includes a predetermined number of pixels 27 which are arranged in a matrix, and each of pixels 27 is lighted in red, green, or blue. Therefore, light beam range A0 determined by the area of light emitter 29 is narrower than original light beam range A by providing black areas Ab on both sides. Light beam range A0 determined by the area of light emitter 29 is a viewing range. Black areas Ab can be formed by not providing light emitter 29 at positions facing boundary portions 31 between microlenses 21.

FIG. 3 is a block diagram illustrating an example of an internal configuration of display device 11 according to the exemplary embodiment. As described above, display device 11 includes display unit 13, microlens array 23 (optical element array), controller 15, and storage 17.

Controller 15 includes a processor such as a central processing unit (CPU), a micro processing unit (MPU), a digital signal processor (DSP), or a field-programmable gate array (FPGA). Controller 15 functions as a controller that controls the operation of display device 11, and performs control processing for centrally controlling the operation of each component of display device 11, processing for exchanging data between the components of display device 11, processing for computing (calculating) data, and processing for storing data. Controller 15 operates according to a program stored in storage 17 such as a memory, thereby being capable of implementing the functions of directional image generator 33 and display controller 35. While operating, controller 15 may access storage unit 17 described above to temporarily store data generated or acquired by controller 15 in the memory (not illustrated).

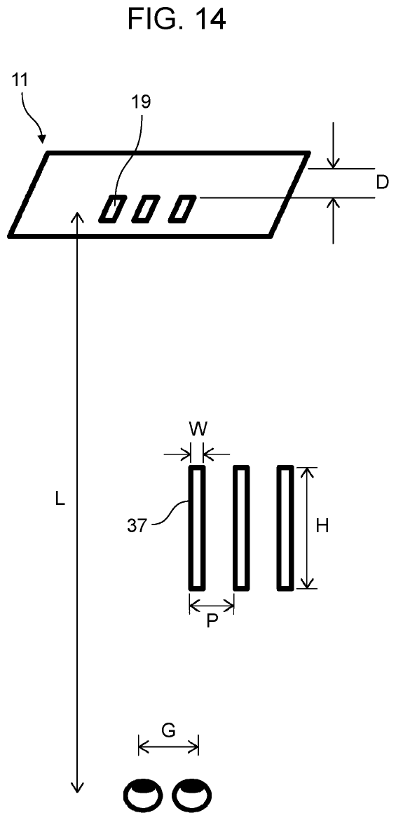

Directional image generator 33 calculates and creates a directional image (that is, a three-dimensional image of a reproduction target that is to be reproduced by display unit 13) to be displayed on display unit 13 on the basis of information from a camera that has captured object 37 (see FIG. 14) to be reproduced. Note that directional image generator 33 may generate the directional image by computation on the basis of information from a computer graphics (CG).

Display controller 35 has a function of aligning microlens 21 and lighting pixel 39 on the basis of the directional image generated by directional image generator 33. That is, display controller 35 adjusts a display position (that is, adjusts the position of lighting pixel 39 and the position of non-lighting pixel 41) such that boundary portion 31 between microlenses 21 and lighting pixel 39 do not overlap each other along a facing direction in which they face each other (that is, a direction perpendicular to a display surface of display device 11 (planar view direction)) (the same applies hereinafter). In this alignment, for example, at least one of horizontal movement, vertical movement, adjustment of a display angle, or scaling of an image is performed. In order to prevent pixel 27 to be lighted from overlapping boundary portion 31 between adjacent microlenses 21, display controller 35 controls to be non-lighting pixel 27 corresponding to at least boundary portion 31 (in other words, pixel 27 overlapping boundary portion 31 along the facing direction). Here, the term “at least” includes meaning that a part of pixel 27 located closer to an optical axis with respect to boundary portion 31 in the optical element may be further controlled to be non-lighting. Note that this alignment function also produces a secondary effect of eliminating the need for alignment between the optical element and display unit 13.

Storage 17 includes, for example, a random access memory (RAM) and a read only memory (ROM), and temporarily stores a program (control data) necessary for the execution of the operation of display device 11 and data generated or acquired during operation. The RAM is, for example, a work memory used while display device 11 is in operation. The ROM stores and holds, for example, a program for controlling display device 11 in advance. For example, storage 17 stores not only the control data described above but also image data to be described later.

FIG. 4 is a schematic diagram illustrating an example of a positional relationship between display unit 13 and microlens array 23 in which non-lighting pixels 41 are provided at positions corresponding to boundary portions 31 between microlenses 21. In display device 11, light emitter 29 (for example, lighting pixel 39) is not provided at a position corresponding to boundary portion 31 between microlenses 21 (in other words, at a position overlapping boundary portion 31 along the facing direction), and this configuration generates an effect of reducing optical crosstalk from certain microlens 21 to microlens 21 adjacent to certain microlens 21. As a result, in display device 11, blurring of stereoscopic image 19 or generation of a double image of stereoscopic image 19 is suppressed, so that the image quality is improved.

Next, first to seventh modifications of display device 11 according to the exemplary embodiment will be described.

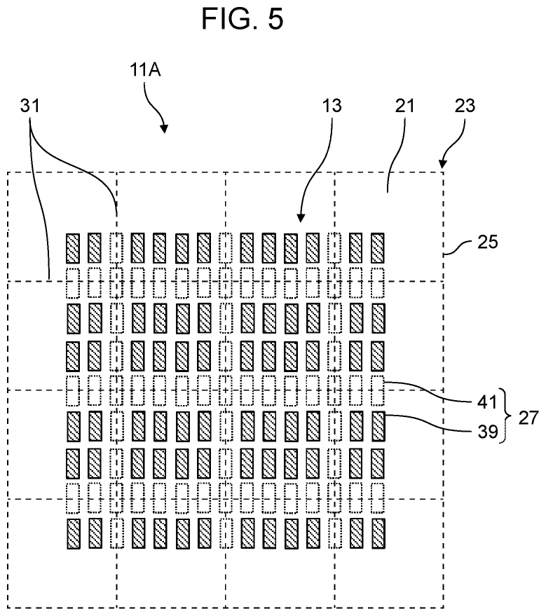

FIG. 5 is a plan view of the first modification in which microlenses 21 in a square array are provided in parallel. In microlens array 23 of display device 11A according to the first modification, the arrangement direction of microlenses 21 may be parallel to the arrangement direction of a plurality of pixels 27. In this case, pixel 27 at a position corresponding to boundary portion 31 between certain microlens 21 and microlens 21 adjacent to certain microlens 21 (in other words, at a position overlapping boundary portion 31 along the facing direction) is also turned into non-lighting pixel 41 controlled to be non-lighting by controller 15.

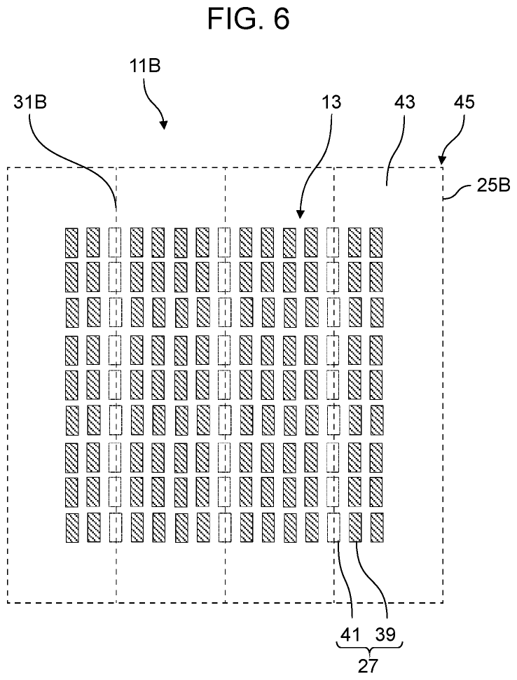

FIG. 6 is a plan view of the second modification in which cylindrical lens 43 is used as a microlens serving as an optical element. In display device 11B according to the second modification, cylindrical lens 43 may be used as the microlens. Cylindrical lens 43 has at least one cylindrical surface, and both surfaces of the lens have generating lines parallel to each other. Multiple cylindrical lenses 43 are arranged in parallel to constitute lenticular lens 45 as the optical element array. In this case, outline 25B shared by adjacent cylindrical lenses 43 among outlines 25B of cylindrical lenses 43 is also defined as boundary portion 31B, and pixel 27 at a position corresponding to boundary portion 31B (in other words, at a position overlapping boundary portion 31B along the facing direction) is also turned into non-lighting pixel 41 controlled to be non-lighting by controller 15.

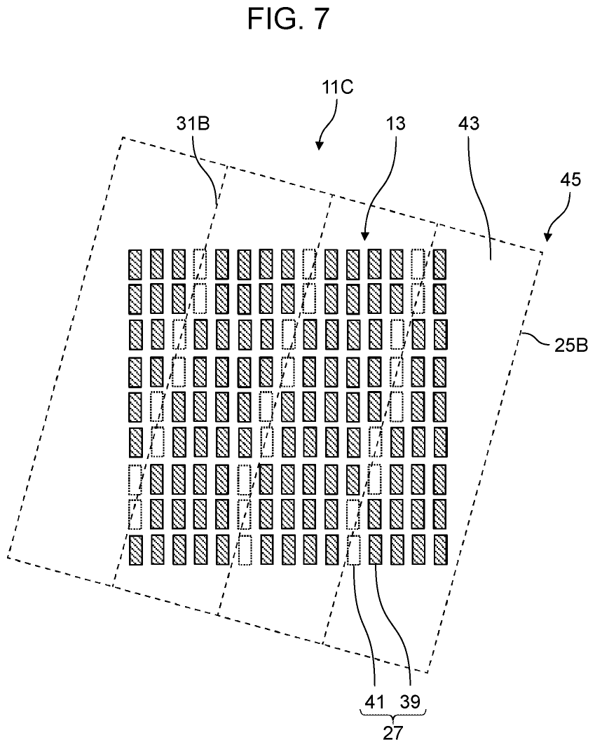

FIG. 7 is a plan view of the third modification in which lenticular lens 45 is provided in a non-parallel manner. In display device 11C according to the third modification, the arrangement direction of lenticular lens 45 in which cylindrical lenses 43 are arrayed in parallel and the arrangement direction of pixels 27 may not be parallel to each other. In this case, pixels 27 overlapping boundary portions 31B between adjacent cylindrical lenses 43 are also turned into non-lighting pixels 41 controlled to be non-lighting.

FIG. 8 is a plan view of the fourth modification in which microlenses 21D each having a hexagonal shape are arranged in a hexagonal array. In display device 11D according to the fourth modification, optical elements of an optical element array may be arranged in a hexagonal array. When the optical element is hexagonal microlens 21D, the optical element array is formed as microlens array 21D in which microlenses 23D are arranged in a hexagonal array. Each of microlenses 21D arranged in a hexagonal array is formed in a hexagonal shape. The hexagon may conceptually include a regular hexagon. Among outlines 25D (six sides) of hexagonal microlenses 21D, outlines 25D shared by microlenses 21D adjacent to each other in microlens array 23D are defined as boundary portions 31D. In this case, pixels 27 at positions corresponding to boundary portions 31D between microlenses 21D (in other words, at positions overlapping boundary portions 31D along the facing direction) are also turned into non-lighting pixels 41 controlled to be non-lighting by controller 15. In microlens array 23D, microlenses 21D adjacent to each other on six sides share the six sides, so that high-density arrangement is possible, and thus, light use efficiency can be enhanced.

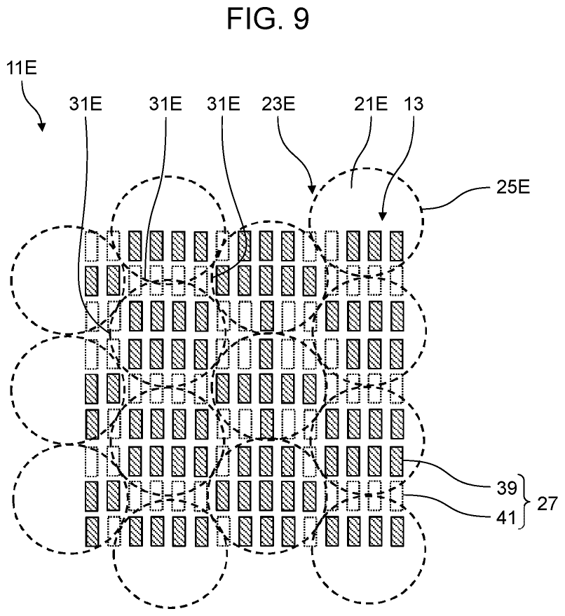

FIG. 9 is a plan view of the fifth modification in which microlenses 21E each having a circular shape are arranged in a hexagonal array. In display device 11E according to the fifth modification, circular microlenses 21E may be arranged in a hexagonal array. In this case, outlines 25E located between adjacent microlenses 21E among outlines 25E (circumferences) of microlenses 21E are defined as boundary portions 31E. Pixels 27 at positions corresponding to boundary portions 31E (in other words, at positions overlapping boundary portions 31E along the facing direction) are turned into non-lighting pixels 41 controlled to be non-lighting by controller 15. Microlens array 23E in which circular microlenses 21E are arranged in a hexagonal array can be relatively easily manufactured.

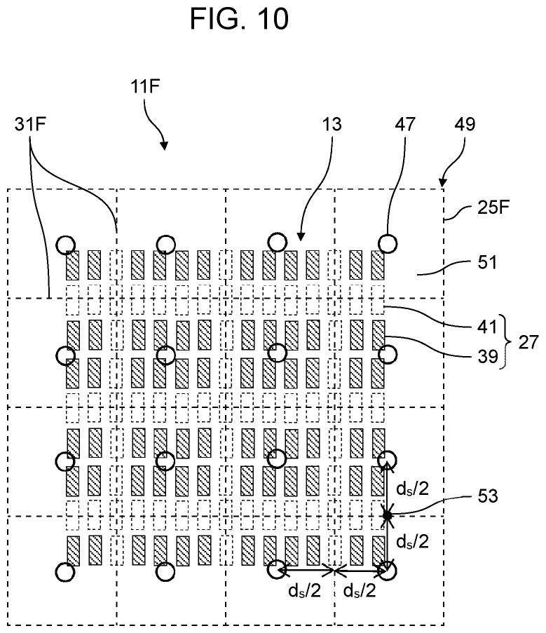

FIG. 10 is a plan view of the sixth modification in which the optical element is pinhole 47. In display device 11F according to the sixth modification, the optical element array may be pinhole array 49 in which pinholes 47, which are a plurality of optical elements, are arrayed. Each of pinholes 47 is formed, for example, at an intersection of a pair of diagonal lines of square pinhole plate 51. In this case, outlines 25F shared by adjacent pinhole plates 51 among outlines 25F of pinhole plates 51 are defined as boundary portions 31F. Pixels 27 at positions corresponding to boundary portions 31F (in other words, at positions overlapping boundary portions 31F along the facing direction) are turned into non-lighting pixels 41 controlled to be non-lighting by controller 15. Midpoint 53 of distance ds between the adjacent pinholes is located on outline 25F. Note that pinhole array 49 may be a single plate having a plurality of regions corresponding to pinhole plates 51 vertically and horizontally.

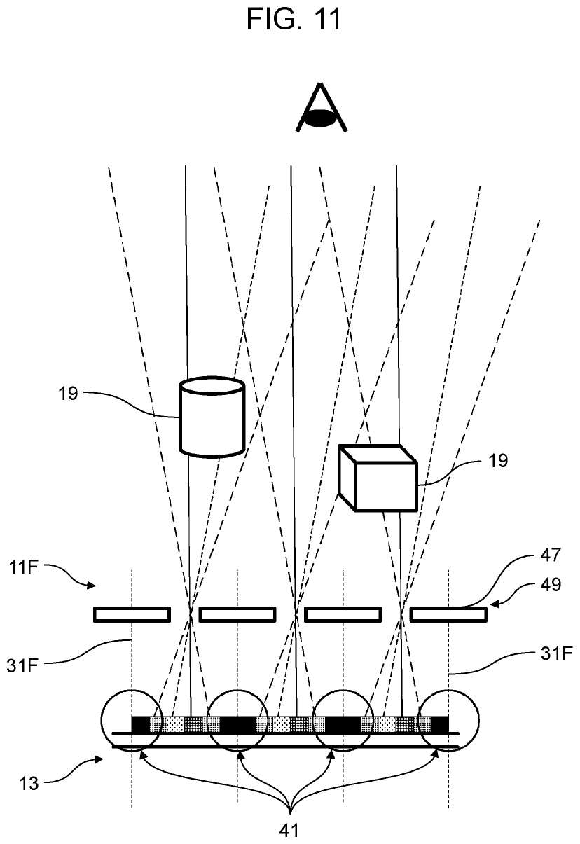

FIG. 11 is a schematic diagram of display unit 13 and pinhole array 49 in which non-lighting pixels 41 are provided at positions corresponding to boundary portions 31F between pinhole plates 51. In display device 11F provided with pinhole array 49, a plurality of pixels 27 arranged vertically and horizontally with a period of RGB in the horizontal direction is arranged inside outline 25F of one pinhole plate 51. Pixels 27 at positions corresponding to boundary portions 31F between certain pinhole plate 51 and pinhole plate 51 adjacent to certain pinhole plate 51 (in other words, at positions overlapping boundary portions 31F along the facing direction) are turned into non-lighting pixels 41 controlled to be non-lighting by controller 15.

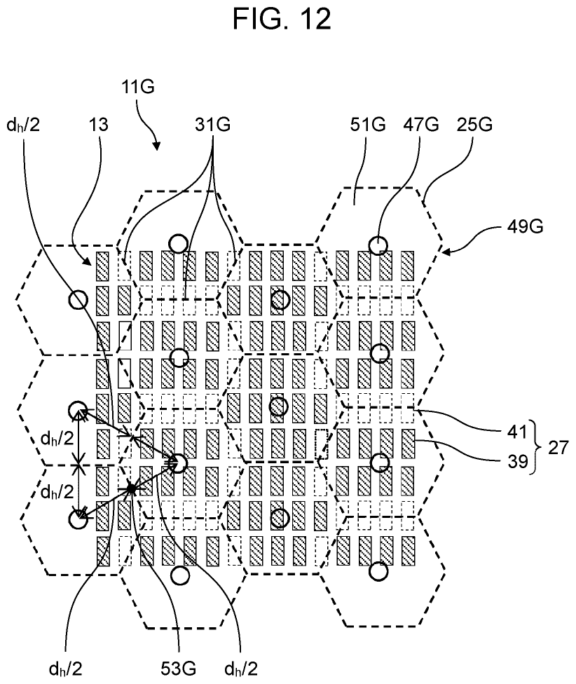

FIG. 12 is a plan view of the seventh modification in which pinhole plates 51G each having a hexagonal shape are arranged in a hexagonal array. In display device 11G according to the seventh modification, pinholes 47G may be arranged in a hexagonal array. In pinhole array 49G having a hexagonal array, each pinhole plate 51G has hexagonal outline 25G. Outlines 25G shared by adjacent pinhole plates 51G in pinhole array 49G among outlines 25G (six sides) of hexagonal pinhole plates 51G are defined as boundary portions 31G. Midpoint 53G of distance dh between the adjacent pinholes is located on outline 25G. In this case, pixels at positions corresponding to six boundary portions 31G that are the sides of pinhole plate 51G (in other words, pixels 27 at positions overlapping boundary portions 31G along the facing direction) are also turned into non-lighting pixels 41 controlled to be non-lighting by controller 15. In pinhole array 49G, pinhole plates 51G adjacent to each other on six sides share the six sides, so that high-density arrangement is possible, and thus, light use efficiency can be enhanced.

Next, a function of display device 11 according to the exemplary embodiment will be described.

Display device 11 according to the exemplary embodiment includes: display unit 13 in which multiple pixels 27 are arrayed in a matrix; the optical element array which is arranged in parallel with the light exit surface of display unit 13 and in which the plurality of optical elements is arranged; and controller 15 that controls pixel 27 among the plurality of pixels 27 to be non-lighting, pixel 27 overlapping at least boundary portion 31 between adjacent optical elements among the plurality of optical elements so as to prevent pixel 27 to be lighted from overlapping boundary portion 31.

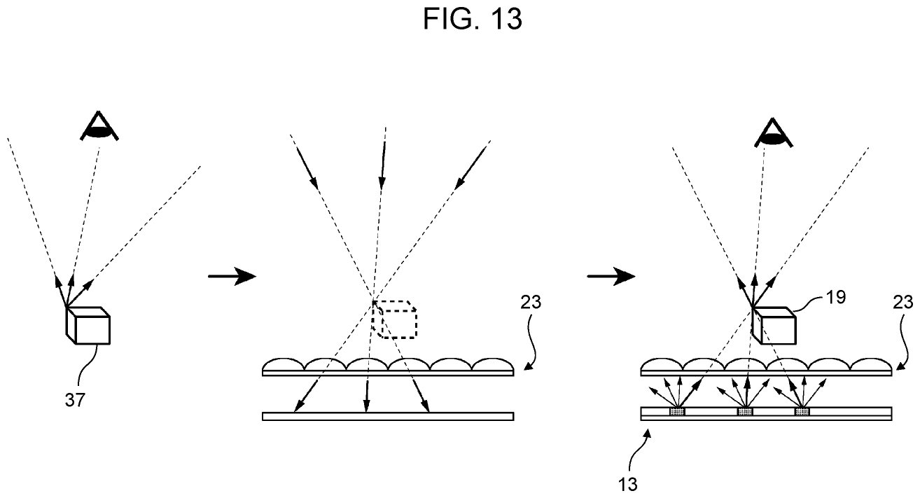

FIG. 13 is a diagram schematically illustrating an example of an operation procedure of creating a stereoscopic image by display device 11 according to the exemplary embodiment. The creation of the stereoscopic image based on the control of non-lighting pixels 41 is performed by ray tracing when object 37 as a subject is imaged by a camera, or ray tracing by object 37 created using CG (see the above). In display device 11 according to the exemplary embodiment, a light beam (specifically, a vector wave passing through object 37 or a vector wave reflected by object 37) emitted from object 37 is stored in storage 17 as image data. Here, the stored light beam is tracked in the reverse direction, and a luminance distribution when the light beam enters the light receiver through microlens array 23 is calculated by controller 15. An original image is calculated by associating the luminance distribution with the light beam. The original image is obtained by reproducing light beams emitted from object 37. By displaying the calculated original image on display unit 13 (that is, by performing control on each of the lighting pixels and the non-lighting pixels on display unit 13), object 37 appears as if the light beams emit from each position in the depth direction, and is visible as stereoscopic image 19.

That is, in display device 11, display unit 13 and microlens array 23 are used to control the direction of light beams, by which the light beams are reconstructed. The position and direction of the light beams emitted from displayed object 37 are reproduced. At this time, the parallax, the focus adjustment, and the convergence match. As a result, the shape, brightness, color, and texture of object 37 according to the viewing angle are reproduced. Thus, natural display like real object 37 is possible.

The optical element array includes multiple optical elements which are arrayed. Examples of the optical element include a microlens and a pinhole. In display unit 13, when an original image is displayed, unnecessary light may be generated because light of each pixel 27 is not unidirectional. For example, when each pixel 27 emits light by light emitter 29 corresponding to the entire region of the light receiving surface of each microlens 21, the light emitted from outermost pixel 27 goes beyond boundary portion 31 with adjacent microlens 21 and enters adjacent microlens 21. In this case, since pixel 27 that is the light emission source is reconstructed such that the light beam exits from each position in the depth direction of stereoscopic image 19, the light beam leaks to adjacent microlens 21 as interference light of light beams that reconstruct stereoscopic image 19. That is, an optical crosstalk occurs. This optical crosstalk causes blurring of stereoscopic image 19 or generation of a double image of stereoscopic image 19 when stereoscopic image 19 is displayed.

Therefore, in display device 11, controller 15 has a function of aligning the optical element and lighting pixel 39. In this alignment, the display position of the image is adjusted such that boundary portion 31 between the optical elements and lighting pixel 39 do not overlap each other along the facing direction. In this alignment function, pixel 27 overlapping at least boundary portion 31 between the adjacent optical elements along the facing direction is controlled to be non-lighting by controller 15.

FIG. 14 is an explanatory diagram illustrating various conditions when the configuration according to the exemplary embodiment is simulated. In FIG. 14, distance L is a distance from both eyes of a viewer to display device 11, and is, for example, 1000 mm. Binocular distance G is a binocular distance of the viewer, and is, for example, 65 mm as an average binocular distance of a person. Width W is a width of object 37, and is, for example, 1 mm. Interval P is an interval between objects 37, and is, for example, 5 mm. Height H is the height of object 37, and is, for example, 15 mm. Distance D is a distance from stereoscopic image 19 formed in front of display device 11 to the display surface, and is, for example, 10 mm.

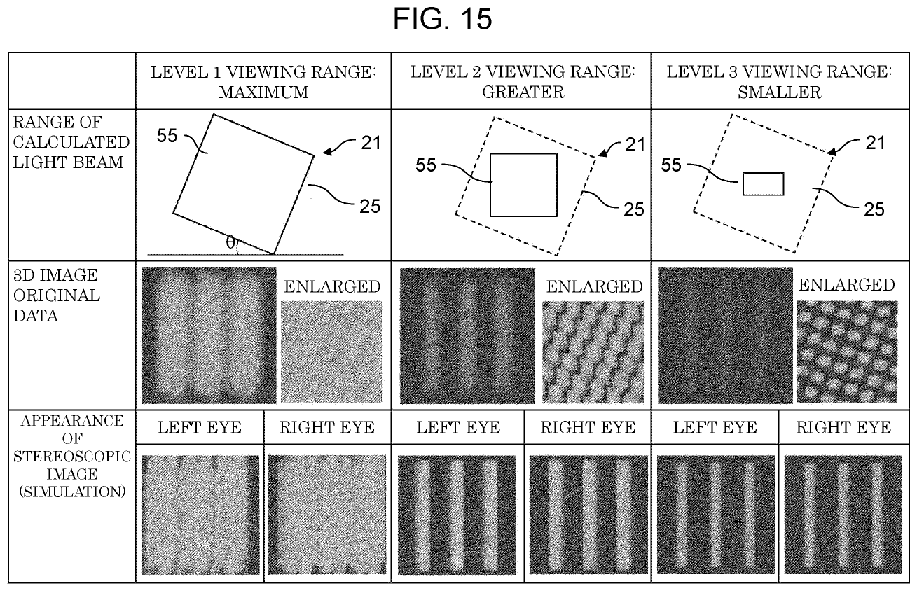

FIG. 15 is an explanatory diagram illustrating a result of simulation in a case where the optical element is microlens 21. The top part of the table represents the range of calculated light beams (that is, viewing range 55). The middle part of the table represents the three-dimensional original data together with an enlarged view of a main part thereof. The lower part of the table shows the appearance (simulation result) of stereoscopic image 19 for each of both eyes.

The left column of the table represents level 1 in which viewing range 55 is the maximum, that is, identical to the area inside outline 25 of microlens 21. The middle column of the table represents level 2 in which viewing range 55 is smaller than that in level 1. The right column of the table represents level 3 in which viewing range 55 is smaller than that in level 2.

When the pixels at the positions overlapping boundary portions 31 are controlled to be non-lighting by controller 15, the pixels inside and along the contour of the optical element form a non-lighting pixel group which is annular and controlled to be non-lighting. That is, a lighting pixel group is surrounded by the non-lighting pixel group. The lighting pixel group surrounded by the non-lighting pixel group forms viewing range 55. When there is no non-lighting pixel group, viewing range 55 corresponds to an area of one optical element.

In viewing range 55, lighting pixels 39 are separated from boundary portions 31 toward the optical axis due to the non-lighting pixel group being provided, whereby interference light that causes the optical crosstalk in which light beams leak to the adjacent optical element is suppressed. As a result, in display device 11, blurring of stereoscopic image 19 or generation of a double image of stereoscopic image 19 is suppressed, whereby the image quality (in other words, display reproducibility of stereoscopic image 19) is improved.

Therefore, according to display device 11 of the exemplary embodiment, it is possible to reduce blurring of stereoscopic image 19 or the generation of a double image of stereoscopic image 19 by suppressing the optical crosstalk to the adjacent optical element of the optical element array in which the plurality of optical elements is arrayed.

When the region of the non-lighting pixel group is small, the effect of suppressing the interference light is reduced, and blurring of stereoscopic image 19 or a double image of stereoscopic image 19 is likely to occur. On the other hand, when the region of the non-lighting pixel group is too large, an easily viewable and clear image can be obtained, but the viewing angle is narrowed, so that the stereoscopic effect is deteriorated. The non-lighting pixel group, that is, viewing range 55, has a trade-off relationship between the level of image quality and the size of viewing angle. Viewing range 55 can be appropriately set according to the use of display device 11 or the like.

Note that controller 15 may control the non-lighting of boundary portion 31 by the alignment function by directional image generator 33 in advance. In this case, display controller 35 executes fine adjustment for further controlling to be non-lighting a part of pixels 27 located closer to the optical axis with respect to boundary portion 31. By such controlling to be non-lighting, display controller 35 can perform fine adjustment for turning lighting pixel 39 that overlaps boundary portion 31 due to deviation from a design value into non-lighting pixel 41 at the time of bonding display unit 13 and the optical element array.

Furthermore, in display device 11, the arrangement direction of pixels 27 and the arrangement direction of microlenses 21, which are optical elements, are not parallel to each other.

In display device 11, the arrangement direction of pixels 27 and the arrangement direction of the optical elements are not parallel to each other. In display unit 13, a plurality of pixels 27 is arranged in a square array in a matrix (in a lattice).

On the other hand, in the optical element array, the plurality of optical elements is also arranged in a square array in a matrix, for example. In this case, pixels 27 arranged in a square array in display unit 13 and the optical elements arranged in a square array in the optical element array have two periodic intensity distributions. When these two periodic intensity distributions are overlapped, a coarse striped moire occurs at the intersection line of the periods.

Furthermore, in display unit 13, a black stripe (an example of a light shielding part) for increasing contrast may be provided along either the vertical direction or the horizontal direction for each of the plurality of pixels 27. In this case, the moire becomes more noticeable.

In view of this, in display device 11, the arrangement direction of pixels 27 and the arrangement direction of the optical elements are not parallel to each other, so that, even if two periodic intensity distributions are overlapped, the line of intersection of the periods is less likely to be generated. This non-parallel state can be obtained, for example, by rotating the optical element array at a predetermined angle around a rotation center perpendicular to the surface of display unit 13 with respect to display unit 13. Accordingly, moire is suppressed.

In addition, in display device 11, the optical element array is microlens array 23 in which microlenses 21 as a plurality of optical elements are arrayed.

In display device 11, a plurality of pixels 27 arranged vertically and horizontally with a period of RGB in the horizontal direction is arranged inside outline 25 of one microlens 21. The pixel corresponding to boundary portion 31 between adjacent microlenses 21 (in other words, pixel 27 that overlaps boundary portion 31 in a three-dimensional manner) is turned into non-lighting pixel 41 under the control of controller 15. Light beams emitted from lighting pixels 39 surrounded by outline 25, that is, from lighting pixels 39 in viewing range 55, are refracted by microlens 21. As a result, the direction of light beams is controlled by the positional relationship between each pixel 27 and microlens 21, and therefore, light beams emitted from object 37 are reconstructed.

Accordingly, by using microlens array 23 provided with the plurality of microlenses 21 as the optical element array, most of light beams entering microlens array 23 can be concentrated at one point, so that an amount of light can be increased.

In addition, in display devices 11F and 11G according to the sixth and seventh modifications, the optical element arrays are pinhole arrays 49 and 49G in which pinholes 47 and 47G, which are a plurality of optical elements, are arrayed.

In display devices 11F and 11G, a light flux having an extremely small diameter among light beams emitted from lighting pixels 39 surrounded by outlines 25F and 25G, that is, from lighting pixels 39 in viewing ranges 55, is emitted in one direction without being refracted by passing through pinholes 47 and 47G. That is, pinholes 47 and 47G have no focal point. The light beams emitted from lighting pixels 39 are inverted by 180° so as to correspond to the position of each light emitter 29 by passing through pinholes 47 and 47G. As a result, the direction of light beams is controlled by the positional relationship between respective pixels 27 and pinholes 47 and 47G, and therefore, light beams emitted from object 37 are reconstructed.

Accordingly, by using pinhole arrays 49 and 49G including the plurality of pinholes 47 and 47G as the optical element array, each light beam emitted from lighting pixel 39 is emitted in one direction unlike microlens array 23 that refracts the light beam to the focal point, so that it is possible to display stereoscopic image 19 without blur regardless of distance.

In addition, in display devices 11B and 11C according to the second and third modifications, the microlens serving as the optical element is cylindrical lens 43.

Cylindrical lens 43 can efficiently split, collect, and scatter light beams. By arranging cylindrical lenses 43 such that their generating lines coincide with the vertical direction, it is possible to display a plurality of parallax images with a relatively simple lens structure as compared with microlenses 21 arranged in a square array.

In addition, in display devices 11D, 11E, and 11G according to the fourth, fifth, and seventh modifications, the optical elements of the optical element array are arranged in a hexagonal array.

In this case, each optical element may have a polygonal shape (rectangular shape, hexagonal shape, etc.) or a circular shape. When each optical element has, for example, a hexagonal shape in the hexagonal array, boundary portions 31D and 31G between the adjacent optical elements on six sides share the respective sides of the hexagon, whereby the optical elements can be arrayed without any gap. As a result, the use efficiency of light emitted from each pixel 27 can be enhanced. In addition, the occurrence of moire can be easily suppressed as compared with the square array.

In addition, in display device 11, light emitter 29 is provided in display unit 13 so as to emit a light beam at an angle smaller than an emission angle of the light beam determined by the focal length of the optical element.

In display device 11, microlens 21, which is an optical element, is arranged at a distance substantially equal to the focal length of microlens 21 from light emitter 29. In this case, light emitter 29 is set to emit a light beam at an angle smaller than the original emission angle of the light beam from light emitter 29 emitted from microlens 21. More specifically, outside pixels 27 are turned into non-lighting pixels 41 with the optical axis of microlens 21 as the center. As a result, light emitter 29 emits a light beam at an angle smaller than the original emission angle of the light beam from light emitter 29. When microlens 21 is projected on display unit 13, outside pixels 27 are located inside and along outline 25 of microlens 21.

When pixel 27 overlaps outline 25 of microlens 21, this pixel 27 is also included in non-lighting pixel 41 at a position along and inside outline 25. That is, display device 11 may further control to be non-lighting a part of pixels 27 located closer to the optical axis with respect to boundary portion 31 between microlenses 21.

The lighting pixel group surrounded by the non-lighting pixel group forms viewing range 55 described above. In viewing range 55, lighting pixels 39 are separated from boundary portions 31 toward the optical axis due to the non-lighting pixel group being provided as described above, whereby interference light that causes the optical crosstalk in which light beams leak to the adjacent optical element is suppressed. As a result, in display device 11, blurring or the generation of a double image of stereoscopic image 19 are suppressed.

While various exemplary embodiments have been described above with reference to drawings, it is obvious that the present disclosure is not limited thereto. It is obvious to those skilled in the art that various modification examples, alteration examples, substitution examples, addition examples, deletion examples, and equivalent examples could be conceived of within the scope of claims, and thus it is obviously understood that those examples belong to the technical scope of the present disclosure. Further, the constituent elements in the various exemplary embodiments described above may be combined as needed without departing from the gist of the present invention.

The present disclosure is useful as a display device that improves display reproducibility by reducing optical crosstalk to adjacent optical elements in an optical element array in which a plurality of optical elements is arranged and by suppressing blurring or generation of a double image of a stereoscopic image to be reproduced.

What is claimed is:

1. A display device comprising:
a display unit including a plurality of pixels that is arrayed;
an optical element array arranged in parallel with a light exit surface of the display unit and including a plurality of optical elements that is arrayed; and
a controller that controls a pixel among the plurality of pixels to be non-lighting, the pixel overlapping a boundary portion between adjacent optical elements among the plurality of optical elements in a facing direction in which the display unit and the optical element array face each other.

2. The display device according to claim 1, wherein an arrangement direction of the plurality of pixels and an arrangement direction of the plurality of optical elements are not parallel.

3. The display device according to claim 1, wherein the optical element array is a microlens array including a plurality of microlenses that is arrayed as the plurality of optical elements.

4. The display device according to claim 1, wherein the optical element array is a pinhole array including a plurality of pinholes that is arrayed as the plurality of optical elements.

5. The display device according to claim 3, wherein each of the plurality of microlenses is a cylindrical lens.

6. The display device according to claim 1, wherein the plurality of optical elements of the optical element array is arranged in a hexagonal array.

7. The display device according to claim 1, wherein the display unit is provided with a light emitter that emits a light beam at an angle smaller than an emission angle of the light beam determined by a focal length of the optical element.
